(19) United States
(12) Patent Application Publication
(10) Pub. No.: US 2024/0198278 A1
(43) Pub. Date: Jun. 20, 2024

(54) SHELVING UNIT WITH WATER MANAGEMENT AND INTEGRATED HEATING FOR SORBENT ARTICLES IN DIRECT AIR CAPTURE SYSTEMS

(71) Applicant: W. L. Gore & Associates, Inc., Newark, DE (US)

(72) Inventors: Christine M. Scotti, Newark, DE (US); Ryan S. Titone, Flagstaff, AZ (US); Edward H. Cully, Clarksville, VA (US)

(21) Appl. No.: 18/544,831

(22) Filed: Dec. 19, 2023

Related U.S. Application Data
(60) Provisional application No. 63/433,949, filed on Dec. 20, 2022.
(60) Provisional application No. 63/611,314, filed on Dec. 18, 2023.

(51) Int. Cl. B01D 53/04; B01D 53/26

(52) U.S. Cl. CPC B01D 53/0446; B01D 53/0415; B01D 53/0438; B01D 53/265; B01D 2257/504; B01D 2259/4009

(57) ABSTRACT

A direct air capture (DAC) device includes a shelving unit to support at least one sorbent article therein and having an upstream location and a downstream location for transporting steam. The shelving unit includes a set of support members forming a plurality of housing portions in which the sorbent article is housed. The support members include first support members extending parallel to each other in a first orientation, and second support members extending parallel to each other in a second orientation different from the first orientation. The second support members include an internal channel configured to receive the desorbing media, and a plurality of openings through which the desorbing media that is received in the internal channel is configured to pass into the housing portion in which the sorbent article is housed to facilitate adsorption

### CROSS REFERENCE TO RELATED APPLICATIONS

This application claims the benefit of U.S. Provisional Application No. 63/433,949, filed Dec. 20, 2022, and U.S. Provisional Application No. 63/611,314, filed Dec. 18, 2023, the disclosures of which are incorporated herein by reference in their entireties for all purposes.

### FIELD

The present disclosure relates to sorbent material composite articles and structures for supporting the sorbent material composite articles during adsorption and desorption processes for direct air capture (DAC) of carbon dioxide (CO₂).

### BACKGROUND

Increasing carbon dioxide (CO₂) levels associated with greenhouse gas emission are shown to be harmful to the environment. As reported by the Climate.gov article “Climate Change: Atmospheric Carbon Dioxide,” the 2019 average CO₂ level in the atmosphere was 409.8 ppm, the highest level that has been noted in the past 800,000 years. The rate of increase of CO₂ in the atmosphere is also reported to be much higher than the rates in previous decades.

In order to limit climate change to acceptable levels, it is not only necessary to reduce CO₂ emissions in the near future to zero but also to achieve negative CO₂ emissions. Several possibilities exist in order to achieve negative emissions, e.g. combustion of biomaterials for the generation of electricity combined with CO₂ capture from the combustion flue gas and subsequent CO₂ sequestration (BECCS) or direct air capture (DAC) of CO₂.

Capturing CO₂ directly from the atmosphere, referred to as DAC, is one of several means of mitigating anthropogenic greenhouse gas emissions and has attractive economic perspectives as a non-fossil, location-independent CO₂ source for the commodity market and for the production of synthetic fuels. The specific advantages of CO₂ capture from the atmosphere include: a) DAC can address the emissions of distributed sources (e.g. vehicles . . . land, sea and air), which account for a large portion of the worldwide greenhouse gas emissions and can currently not be captured at the site of emission in an economically feasible way; b) DAC can address legacy emissions and can therefore create truly negative emissions, and c) DAC systems do not need to be attached to the source of emission but may be location independent and can be located at the site of further CO₂ processing or usage.

There is increasing motivation to develop and improve upon the structures for facilitating adsorption and desorption cycles for sorbent material such that these processes may be performed more efficiently.

### SUMMARY

A direct air capture (DAC) device and methods of controlling the same are disclosed herein. In one example (“Example 1”), a shelving unit for a DAC device is configured to support at least one sorbent article therein and having an upstream location and a downstream location for transporting steam. The shelving unit includes a set of support members forming a plurality of housing portions in which the sorbent article is housed. The support members include first support members extending parallel to each other in a first orientation and second support members extending parallel to each other in a second orientation different from the first orientation. The second support members include an internal channel configured to receive the desorbing media, and a plurality of openings through which the desorbing media that is received in the internal channel is configured to pass into the housing portion in which the sorbent article is housed to facilitate adsorption.

In another example (“Example 2”) further to Example 1, the shelving unit includes a manifold defining at least one inlet configured to receive the desorbing media at the upstream location of the frame, and the internal channel is configured to extend from and fluidly coupled with the inlet for the internal channel to receive the desorbing media.

In another example (“Example 3”) further to Example 1 or 2, the internal channel includes a plurality of extension portions formed around the openings on a surface of the second support members and extending inwardly into the internal channel from the surface.

In another example (“Example 4”) further to Example 3, the extension portions define a reservoir formed in the internal channel and configured to collect water condensation inside the internal channel.

In another example (“Example 5”) further to any one of the preceding Examples, the second support members further include: at least one cooling channel located inside the internal channel and configured to facilitate collecting water by cooling the steam located inside the internal channel.

In another example (“Example 6”) further to Example 5, the second support members further include: at least one heating element located inside the internal channel and configured to generate the steam using the water collected inside the internal channel by heating the water located inside the internal channel.

In another example (“Example 7”) further to any one of the preceding Examples, the shelving unit includes a perforation control mechanism operatively coupled with the openings configured to control opening and closing of the openings.

In one example (“Example 8”), a direct air capture (DAC) device has an upstream location and an opposing downstream location with an inflow received by the DAC device at the upstream location. The DAC device also includes a plurality of first cartridges disposed adjacent to each other with each first cartridge supporting a plurality of first sorbent articles, the plurality of first cartridges disposed proximate to the upstream location. The DAC device also includes a plurality of second cartridges disposed adjacent to each other with each second cartridge supporting a plurality of second sorbent articles, the plurality of first cartridges disposed between the upstream location and the plurality of second cartridges. The DAC device also includes at least one channel extending from the upstream location through the plurality of first cartridges and through the plurality of second cartridges, a first portion of the at least one channel disposed to deliver a first portion of the inflow to the plurality of first cartridges and a second portion of the at least one channel disposed to deliver a second portion of the inflow to the plurality of second cartridges.

In another example (“Example 9”) further to Example 8, the DAC device also includes a manifold disposed between the inflow and the at least one channel.

In another example (“Example 10”) further to Example 8 or 9, the second portion of the inflow does not pass through the first plurality of cartridges.

In another example (“Example 11”) further to any one of Examples 8-10, the first and second portions of the inflow each have a same concentration of a component as the first portion of the inflow engages the plurality of first cartridges and the second portion of the inflow engages the plurality of second cartridges.

In another example (“Example 12”) further to any one of Examples 8-11, the at least one channel includes a plurality of extension portions formed around openings and extending inwardly into the at least one channel.

In another example (“Example 13”) further to any one of Examples 8-12, the extension portions define a reservoir formed in the at least one channel and configured to collect water condensation inside the at least one channel.

In another example (“Example 14”) further to any one of Examples 8-13, the at least one channel includes a cooling channel configured to facilitate collecting water by cooling steam located inside the at least one channel.

In another example (“Example 15”) further to any one of Examples 8-14, the at least one channel includes a heating element configured to generate steam using the water collected inside the at least one channel by heating the water located inside the at least one channel.

In another example (“Example 16”) further to any one of Examples 8-15, the DAC device further includes a perforation control mechanism operatively coupled with the openings configured to control opening and closing of the openings.

In one example (“Example 17”), a direct air capture (DAC) device has an upstream location and an opposing downstream location with an inflow received by the DAC device at the upstream location. The DAC device includes a plurality of cartridges disposed adjacent to each other with each cartridge supporting a plurality of sorbent articles, the plurality of cartridges including top cartridges disposed above bottom cartridges, the top and bottom cartridges each extending between the upstream and downstream locations. The DAC device also includes a top channel disposed above the top cartridges and extending along a length of the top cartridges to collect water provided by a top portion of the inflow. The DAC device also includes a bottom channel disposed below the bottom cartridges and extending along a length of the bottom cartridges to collect water provided by a bottom portion of the inflow. The DAC device also includes a middle channel disposed between the top and bottom cartridges and extending along at least one of the top cartridge length and the bottom cartridge length to collect water provided by a middle portion of the inflow. The DAC device also includes a common outlet disposed to receive water from at least one of the top channel, the middle channel, and the bottom channel. The top channel includes a top-channel upper surface disposed over a top-channel lower surface within the top channel, the top-channel lower surface including reservoirs and perforations disposed between the reservoirs, the top-channel upper surface including top-channel drip points shaped to collect water over the top-channel reservoirs, the top-channel reservoirs communicating to deliver the water to a top-channel outlet communicating with the common outlet.

In another example (“Example 18”) further to Example 17, the bottom channel includes a bottom-channel upper surface disposed over a bottom-channel lower surface within the bottom channel, the bottom-channel lower surface including a bottom-channel reservoir, the bottom-channel upper surface including perforations defining bottom-channel drip points shaped to collect water over the bottom-channel reservoir, the bottom-channel reservoir communicating to deliver the water to a bottom-channel outlet communicating with the common outlet.

In another example (“Example 19”) further to Example 17 or 18, the middle channel includes a middle-channel upper surface disposed over a middle-channel lower surface within the middle channel, the middle-channel lower surface including reservoirs and perforations disposed between the reservoirs, the middle-channel upper surface including perforations defining middle-channel drip points shaped to collect water over the middle-channel reservoirs, the middle-channel reservoirs communicating to deliver the water to a middle-channel outlet communicating with the common outlet.

In another example (“Example 20”) further to any one of Examples 17-19, at least one of the top channel, the bottom channel, and the middle channel is angled to use gravity to increase a delivery of water to the common outlet.

In another example (“Example 21”) further to any one of Examples 17-20, the DAC device further includes a manifold disposed between the inflow and at least one of the top channel, the bottom channel, and the middle channel.

In another example (“Example 22”) further to any one of Examples 17-21, the top channel includes a top-channel cooling channel configured to facilitate collecting water by cooling steam located inside the top channel.

In another example (“Example 23”) further to any one of Examples 17-22, the top channel includes a top-channel heating element configured to generate steam using the water collected inside the top channel by heating the water located inside the top channel.

In another example (“Example 24”) further to any one of Examples 17-23, the bottom channel includes a bottom-channel cooling channel configured to facilitate collecting water by cooling steam located inside the bottom channel.

In another example (“Example 25”) further to any one of Examples 17-24, the bottom channel includes a bottom-channel heating element configured to generate steam using the water collected inside the bottom channel by heating the water located inside the bottom channel.

In another example (“Example 26”) further to any one of Examples 17-25, the middle channel includes a middle-channel cooling channel configured to facilitate collecting water by cooling steam located inside the middle channel.

In another example (“Example 27”) further to any one of Examples 17-26, the middle channel includes a middle-channel heating element configured to generate steam using the water collected inside the middle channel by heating the water located inside the middle channel.

In another example (“Example 28”) further to any one of Examples 17-27, the DAC device further includes a perforation control mechanism operatively coupled with the perforations configured to control opening and closing of the perforations.

In one example (“Example 29”), a method for removing gaseous carbon dioxide from an atmosphere includes: receiving information about a dispersion of a first quantity of gaseous carbon dioxide into the atmosphere at a first location; initiating a method of separating a second quantity of gaseous carbon dioxide from the atmosphere at a second location, the second quantity being at least a portion of the first quantity, wherein the method of separating includes the use of the device of any one of Examples 1-28; and initiating a reporting of data regarding the second quantity.

In one example (“Example 30”), a method for removing gaseous carbon dioxide from an atmosphere includes: receiving information about a first quantity of gaseous carbon dioxide; separating a second quantity of gaseous carbon dioxide from the atmosphere, the second quantity being at least a portion of the first quantity, wherein the method of separating includes the use of the device of any one of Examples 1-28; and reporting data regarding the second quantity.

In one example (“Example 31”), a method for removing gaseous carbon dioxide from an atmosphere includes: transmitting information about a dispersion of a first quantity of gaseous carbon dioxide into the atmosphere at a first location; requesting initiation of a method of separating a second quantity of gaseous carbon dioxide from the atmosphere at a second location, the second quantity being at least a portion of the first quantity, wherein the method of separating includes the use of the device of any one of Examples 1-28; and receiving a reporting of data regarding the second quantity.

In one example (“Example 32”), a method for removing gaseous carbon dioxide from an atmosphere includes: receiving, from a computing device, a first electronic communication comprising information about a dispersion of a first quantity of gaseous carbon dioxide into the atmosphere at a first location; initiating a separating, by a carbon capture device, of a second quantity of gaseous carbon dioxide from the atmosphere at a second location, the second quantity being at least a portion of the first quantity, wherein the carbon capture device is the device of any one of Examples 1-28; and initiating a reporting of data associated with the carbon capture device regarding the second quantity, wherein the data forms part of a second electronic communication.

In another example (“Example 33”) further to Example 32, the second electronic communication is configured to be transmitted to the computing device.

In another example (“Example 34”) further to Example 32 or 33, the second electronic communication is configured to be transmitted to an additional computing device.

In one example (“Example 35”), a method for removing gaseous carbon dioxide from an atmosphere includes: receiving, from a computing device, a first electronic communication comprising information about a first quantity of gaseous carbon dioxide; separating, by a carbon capture device, a second quantity of gaseous carbon dioxide from the atmosphere, the second quantity being at least a portion of the first quantity, wherein the carbon capture device is the device of any one of Examples 1-28; and reporting, as a second electronic communication, data associated with the carbon capture device regarding the second quantity.

In another example (“Example 36”) further to Example 35, the second electronic communication is configured to be transmitted to the computing device.

In another example (“Example 37”) further to Example 35 or 36, the second electronic communication is configured to be transmitted to an additional computing device.

In one example (“Example 38”), a method for removing gaseous carbon dioxide from an atmosphere includes: transmitting, to a computing device, a first electronic communication comprising information about a dispersion of a first quantity of gaseous carbon dioxide into the atmosphere at a first location; requesting a separating, by a carbon capture device, of a second quantity of gaseous carbon dioxide from the atmosphere at a second location, the second quantity being at least a portion of the first quantity, wherein the carbon capture device is the device of any one of Examples 1-28; and receiving a second electronic communication comprising an indication of a reporting of data associated with the carbon capture device regarding the second quantity.

In another example (“Example 39”) further to Example 38, the second electronic communication is received from the computing device.

In another example (“Example 40”) further to Example 38 or 39, the second electronic communication is received in response to transmitting the first electronic communication.

In one example (“Example 41”), a method for removing gaseous carbon dioxide from an atmosphere includes: receiving information about a dispersion of a first quantity of gaseous carbon dioxide into the atmosphere at a first location; initiating a separating of a second quantity of gaseous carbon dioxide from the atmosphere at a second location, the second quantity being at least a portion of the first quantity, wherein the separating includes the use of the device of any one of Examples 1-28; and initiating a reporting of data regarding the second quantity.

In one example (“Example 42”), a method for removing gaseous carbon dioxide from an atmosphere includes: transmitting information about a dispersion of a first quantity of gaseous carbon dioxide into the atmosphere at a first location; requesting a separating a second quantity of gaseous carbon dioxide from the atmosphere at a second location, the second quantity being at least a portion of the first quantity, wherein the separating includes the use of the device of any one of Examples 1-28; and receiving a reporting of data regarding the second quantity.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1A is an illustration of a shelving unit for a direct air capture (DAC) device according to embodiments disclosed herein.

FIG. 1B is an illustration of the shelving unit of FIG. 1A partially filled with sorbent articles disposed therein according to embodiments disclosed herein.

FIG. 1C is an illustration of the shelving unit of FIG. 1A entirely filled with sorbent articles disposed therein according to embodiments disclosed herein.

FIG. 1D is a schematic diagram of a multi-phase process for adsorption and desorption having directions of fluid transport shown with respect to a sorbent assembly, according to embodiments disclosed herein.

FIG. 2 is an illustration of a shelving unit with internal channels to be used during one of the adsorption/desorption processes, according to embodiments disclosed herein.

FIGS. 3A and 3B are illustrations of a shelving unit with internal channels with openings and dimpled surfaces, according to embodiments disclosed herein.

FIG. 4 is an illustration of a shelving unit with angled housing portions, according to embodiments disclosed herein.

FIGS. 5A and 5B are illustrations of a shelving unit with heating elements implemented therein, according to embodiments disclosed herein.

FIG. 6A is a schematic sideview of a DAC device during one of the adsorption/desorption processes, according to embodiments disclosed herein.

FIG. 6B is a schematic sideview of a DAC device during another during one of the adsorption/desorption processes, according to embodiments disclosed herein.

FIG. 6C is a partial view of a portion of a conduit with a perforation control mechanism implemented therewith, according to embodiments disclosed herein.

FIG. 7 is an isometric view of a shelving unit with dimpled surfaces to be used during one of the adsorption/desorption processes, according to embodiments disclosed herein.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

Furthermore, the term “direct air capture (DAC) device” is defined to include examples with a single DAC cartridge and with multiple DAC cartridges (in a stacked configuration, for example, as further explained herein). The term “DAC cartridge” is defined to include a single frameless or framed structure (with any suitable framework defining the shape and size of the structure, as further explained herein) that is at least partially filled with sorbent material composite article(s) and can be used for capturing CO₂ directly from the atmosphere. As defined herein, a DAC device is also referred to as a carbon capture device capable of carrying out any method for separating gaseous CO₂ from a gas mixture in the form of ambient air. Example sorbent articles and cartridges supporting sorbent articles are further disclosed in International Publication Nos. WO 2022/187730 (W. L. Gore & Associates, Inc.) and WO 2022/187733 (W. L. Gore & Associates, Inc.), the disclosures of which are incorporated herein by reference in their entireties for all purposes.

### Description of Various Embodiments

The present disclosure relates to devices for use in direct air capture (DAC) to adsorb and separate one or more desired substances from a source stream or flow, such as carbon dioxide (CO₂) from a dilute feed stream, such as air. Such DAC devices may also be used in other adsorbent methods and applications. These methods include, but are not limited to, adsorption of substances from various inputs, including other gas feed streams (e.g., combustion exhaust) and liquid feed streams (e.g., ocean water). The adsorbed substance is not limited to CO₂. Other adsorbed substances may include, but are not limited to, other gas molecules (e.g., N₂, CH₄, and CO), liquid molecules, and solutes. In certain embodiments, the input may be dilute, containing on the order of parts per million (ppm) of the adsorbed substance.

An example of articles and techniques for DAC includes using an article including a substrate such as a monolith that can support or be coated with a sorbent material. Variations are established by changing the type of substrate and the sorbent that is used. However, these previously established articles and methods present limitations in the ability to efficiently cycle between adsorbing and desorbing states. They also have limitations with respect to the energy required to perform the process.

Many times, swing adsorption is a very energy intense process. Whether Pressure Swing, Temperature Swing or Moisture Swing, energy is needed during many of the phases of operation.

As an example, in Temperature-Vacuum Swing Adsorption (TVSA) for Direct Air Capture (DAC) of CO₂, the adsorption step may require fans to force large volumes of air through an air contactor, such as ceramic monolith or plate-pack having a series of adjacent plates with a spacing therebetween. At a point when the operator deems it useful to begin desorption (usually when the contactor has adsorbed an amount of CO₂), the fans may be turned off or deactivated to terminate the adsorption phase.

Once the adsorption phase terminates, the inlet and outlet of the module are closed, which provides a seal for negative pressure. Next, vacuum may be applied to evacuate air within the module and steam is applied to increase the temperature to the point where the sorbent releases CO₂. This CO₂ is then pumped out of the module space and is further processed to remove humidity. Of the aforementioned processes, the desorption step requires significant energy to heat and then cool the module. During desorption, the temperature in the entire module volume must be increased from ambient (which, depending on geographic location, may be extremely cold) to the temperature which facilitates CO₂ removal from the sorbent. In many cases steam is used for this increase in temperature since steam is efficient at transferring heat to a substance. An object of the present invention is to increase the efficiency of a DAC system by providing a module which is capable of variable volume. As an example, the air contactor or module may have one volume during the adsorption step which allows air to flow through it at a very low pressure, thereby facilitating adsorption of CO₂ and at least a second, reduced volume during the desorption step which provides an energy savings by reducing the amount of volume that needs to be increased in temperature. Reducing the volume will also reduce the energy required to apply negative pressure, although in some cases the negative pressure maybe the force that causes the volume reduction.

Similarly, in moisture swing and pressure swing adsorption processes, it is the desorption step that is typically the most energy intensive. In moisture swing, energy used in moving moisture to the contactor and energy used in drying the contactor once the CO₂ is desorbed from it. In pressure swing, energy is used to apply pressure to the sorbent to cause the CO₂ to release from it. In both cases it may also be beneficial to provide an air contactor or module which is capable of variable volume configurations. Current state air contactors and modules are deficient in this respect.

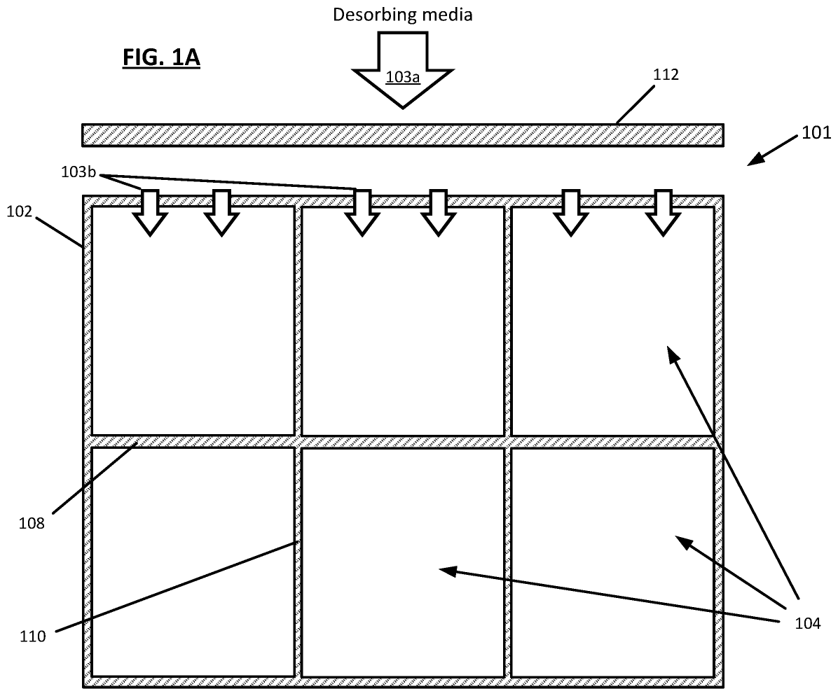

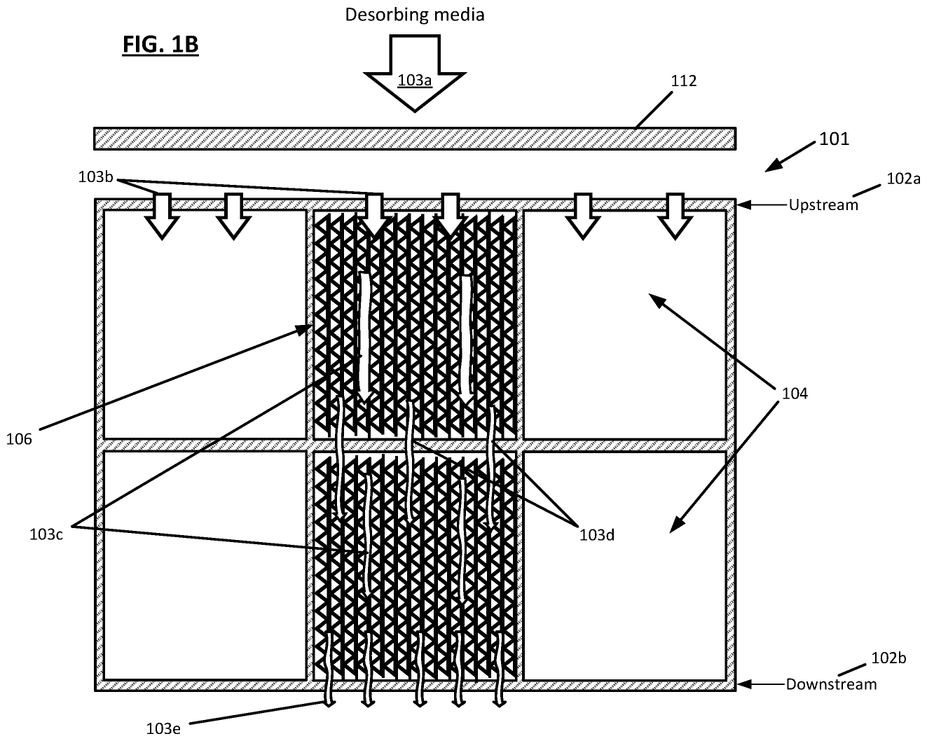

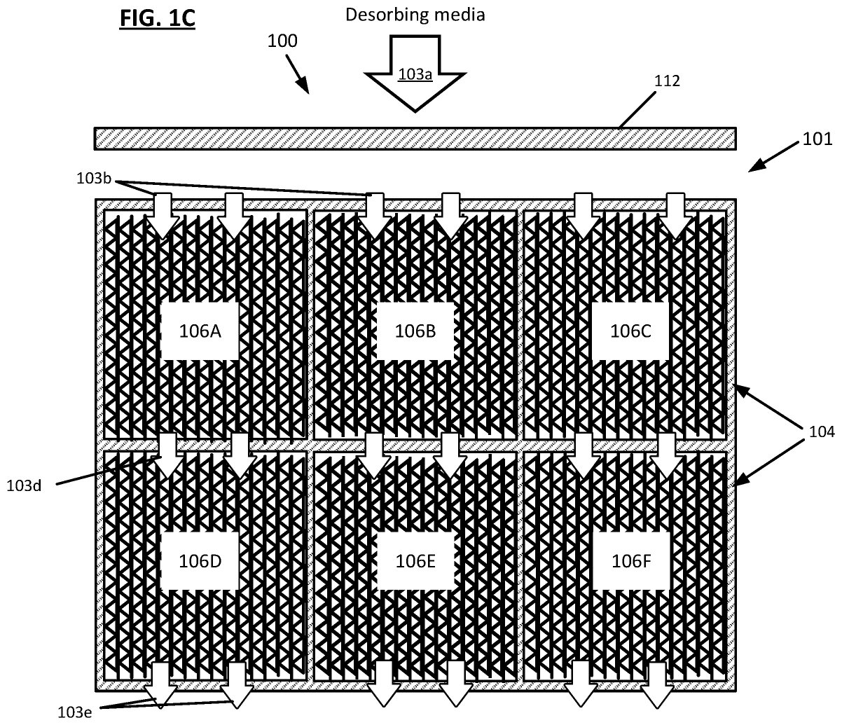

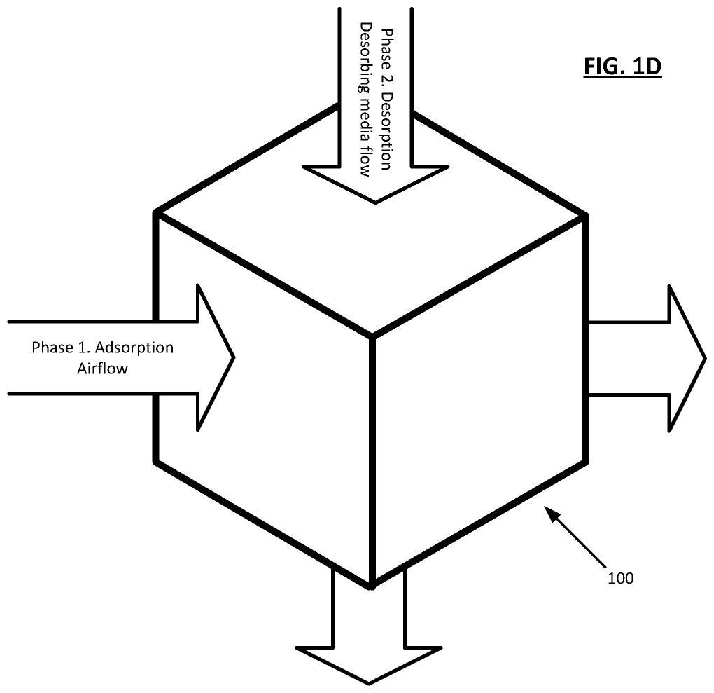

FIG. 1A shows a shelving unit 101 for a DAC device 100. The shelving unit 101 includes a frame, a support framework, or a frame structure 102 to hold or support therein a plurality of sorbent articles 106 as shown in FIGS. 1B and 1C, or cartridges holding a plurality of sorbent articles. The articles 106 may be held in place within the DAC device 100 (also referred to herein as a DAC assembly) as shown in FIG. 1C using the frame structure 102 which includes a plurality of holes or perforations (not shown) through which fluid such as desorbing media (which in some examples may be one or more of: hot liquid, steam, saturated steam, superheated liquid, or any substance that transfers heat, etc.) is allowed to pass through during the adsorption/desorption processes as explained above. The desorbing media as referred to herein may include one or more of: hot liquid, steam, saturated steam, superheated liquid, or any substance that transfers heat, etc., as further disclosed in U.S. application Ser. No. 18/234,014 (W. L. Gore & Associates, Inc.), the disclosure of which is incorporated herein by reference in its entirety for all purposes. The articles 106 may be inserted or disposed in and supported by housing portions 104 (also referred to as chambers or internal volumes) of the shelving unit 101 to form the DAC device 100, which may be installed in the DAC reactor, in any suitable configuration as further explained herein. The DAC reactors as referred to herein may include those as further disclosed in International Publication Nos. WO 2021/239747 (Climeworks AG) and WO 2023/104656 (Climeworks AG), the disclosures of which are incorporated herein by reference in its entirety their entireties for all purposes.

The shelving unit 101 has two types of dividers: a first divider 108 and a second divider 110, which separate the different housing portions 104 from each other. The first divider 108 in some examples may be substantially vertical, and the second divider 110 in some examples may be substantially horizontal. As further disclosed therein, there may be additional different orientations that can be assumed by the dividers. The dividers 108 and 110 may divide the internal volume of the shelving unit 101 into rows and columns of individual housing portions 104, such that the articles 106 or cartridges of articles 106 may be inserted into their respective housing portions. The dividers 108, 110 and the frame structure 102 may include holes or perforations (not shown explicitly in FIGS. 1A-1C but represented schematically by arrows passing through the frame structure 102 and dividers 108, 110) such that fluid flow (such as air flow or flow of desorbing media) may flow in to, out of, and between neighboring housing portions 104.

The shelving unit 101 may also have a distribution plate 112 or manifold which operates to evenly distribute the incoming fluid, such as air and/or desorbing media stream 103a or flow (represented schematically by a large arrow), into smaller and more numerous fluid media streams 103b, 103c, and 103d or flows (represented schematically by smaller and more numerous arrows; see FIG. 1B) into the individual housing portions 104, to facilitate more efficient adsorption and desorption processes. The fluid media streams may further pass between housing portions 104 in streams 103d and/or exit the shelving unit 101 in streams 103e if necessary for the adsorption or desorption process. The distribution plate 112 can provide channels or openings that cause the smaller fluid streams to be consistent with each other as determined by measurable parameters such a flow velocity, pressure drop, density changes, temperature changes, or observable flow pathways. Alternatively, the distribution plate 112 can provide channels or openings that direct greater flow to specific areas connected to the distribution plate 112, such as by providing greater flow to openings nearer to the peripheral edges of the distribution plate 112, less flow to a center of the distribution plate 112, and/or greater flow to corners of the distribution plate 112.

As shown, the frame structure 102 of the shelving unit 101 may be a single, unitary construct which includes multiple compartments or housing portions (spaces) 104 for discretization of the sorbent articles 106. The sorbent articles 106 or cartridges of sorbent articles may be stored or housed within each compartment/housing portion 104 such that different types of sorbent articles may be stored or housed within different compartments/housing portions, as well as reducing the need for the individual sorbent articles to be self-supporting or supported by cartridges.

The shelving unit 101 may facilitate passage of airflow in to, out from, and between different compartments/housing portions 104 so as to allow air to flow from one location to another. Such airflow facilitates drying of the sorbent articles after being subjected to desorbing media (e.g., steam) during adsorption and desorption processes. As further disclosed herein, the shelving unit 101 may include means of collecting condensation formed during the adsorption and desorption processes (e.g., water formed as a result of steam vapor condensation). In some examples, the condensation that is collected may be reused in a subsequent adsorption and desorption process, thereby providing efficient cycling of desorbing media. In some examples, the condensation that is collected may be redirected to a drainage outlet. The shelving unit 101 may include localized or integrated heating/cooling features such as a circuit for providing chilled water and a heating element to form steam vapor from the liquid water collected in the shelving unit 101, as further disclosed herein.

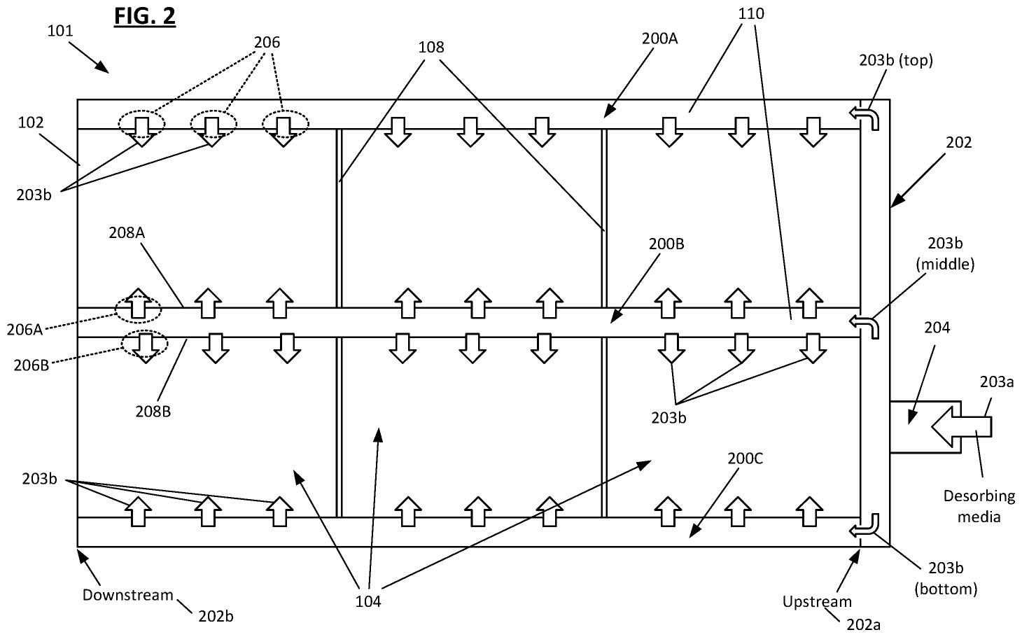

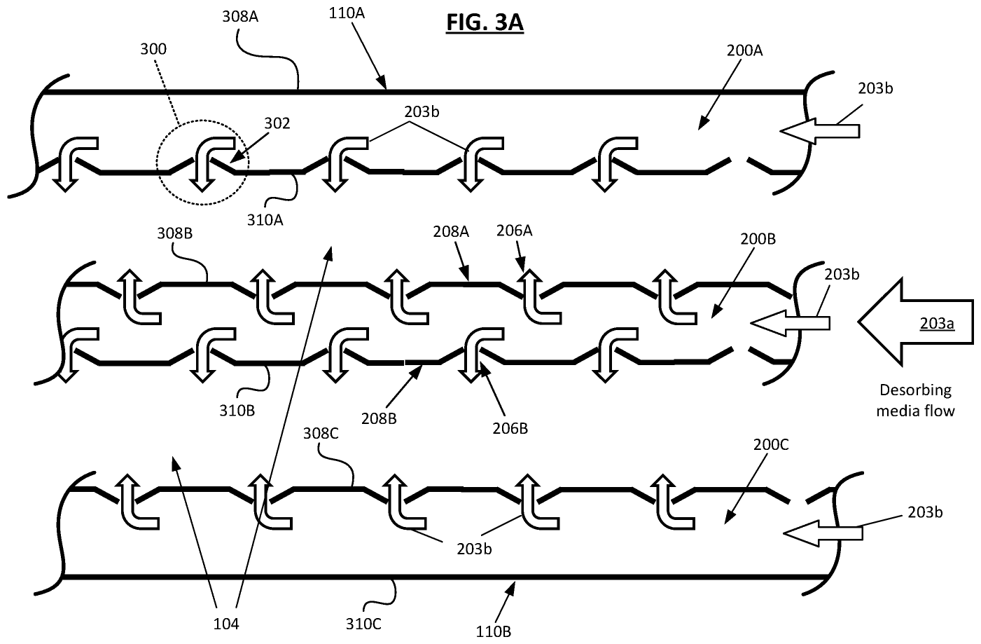

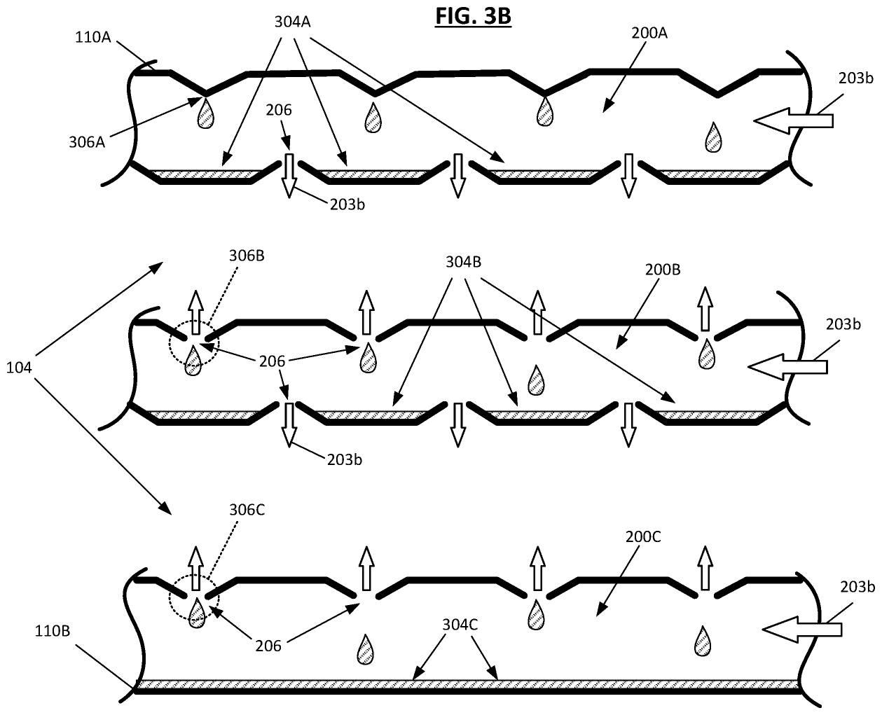

In FIG. 11B, the flow of media stream 103c (represented schematically by multiple long wiggling arrows) passing through the sorbent articles 106 (also referred to as air contactors) dissipates as the media stream 103b comes into contact with the sorbent articles 106, as shown by the arrows 103c becoming more numerous and thinner as they progress downstream. The frame structure 102 has an upstream location 102a and a downstream location 102b defining a pathway through the frame 102 for transporting the desorbing media, as shown by the arrows 103c which point from the upstream location toward the downstream location. Desorbing media enters the frame 102 through the distribution plate 112 and then enters the frame 102 at the upstream location 102a. Air contactors or sorbent articles 106 are in place inside the housing portion (or space) 104 of the frame 102. In the illustrated example, the shelving unit 101 is fabricated with supports for each sorbent article 106 to maintain the position of each sorbent article 106 in a desired position within the housing portion 104. Alternatively, housing portion 104 can be subdivided to provide multiple adjacent separate housing compartments within the space 104 that each individually support a sorbent article 106. In some examples, there may be multiple inlets from which the desorbing media may be introduced into the frame 102 (as shown in FIGS. 2, 3A, and 3B, for example). In some examples, different sorbent articles 106 may be included in separate housing portions (or spaces) 104 within the same frame 102.

In FIG. 1C, six (6) sets of multiple sorbent articles 106 are shown, labeled as set “106A” through set “106F.” In some examples, each set may vary in one or more of: the spacing between neighboring articles (air contactors) 106 within a set, the type of sorbent material used within a set, the amount of sorbent material used, etc. The dividers 108 and 110 (FIG. 1A) may facilitate the passage of air or desorbing media from set 106A to set 106D, from set 106B to set 106E, and/or from set 106C to set 106F as illustrated by flow or stream 103d, or to the exterior of the unit 101 by flow or stream 103e. In some examples, a portion of the stream of desorbing media may travel side-to-side instead of simply downstream, for example from 106A to 106B, from 106D to 106E, etc. As can be appreciated, the dividers 108 and 110 can be advantageously disposed to direct the media stream in side-to-side and/or downstream directions.

In some examples, the media stream 103 passing through the DAC device 100 may be any suitable feed stream during each cycle of adsorption and desorption. The feed stream may be the air passing through the DAC device 100, and the one or more components may include CO₂ or any other aforementioned gas molecules, for example. In some examples, desorbing the articles 106 may include submerging the articles 106 into a desorption source such as water (or alternatively using steam or heat as the desorption source in some examples) in order to desorb the CO₂. The feed stream may then escape from the DAC device 100 as gas or vapor.

As shown in FIG. 1D, crossflow of the DAC device 100 is defined by two phases. In a first adsorption phase (Phase 1), air passes into the cartridge that is filled with sorbent articles (sorbent assembly), which is shown as a cube in the figure, in a first direction as shown by the horizontal arrows. During Phase 1, carbon dioxide from the incoming air is captured inside the sorbent assembly. In a second desorption phase (Phase 2) which follows Phase 1, desorbing media passes into the cartridge in a second direction as shown by the vertical arrows. The vertical and horizontal directions are interchangeable. The cartridge or sorbent assembly may cycle between Phase 1 and Phase 2 such that the subsequent Phase 1 following Phase 2 may facilitate drying the sorbent assembly which may be moist or wet from the application of the desorbing media (e.g., steam) during Phase 2. Advantageously, cross-flow facilitates efficient drying of sorbent articles for improved efficiency of adsorption/desorption cycles.

In FIG. 2A, a sideview of a shelving unit 101 is illustrated as having a desorbing media flow 203 entering the unit 101 as flow (or inflow) 203a at the beginning of a passage extending (leftwards in FIG. 2) through the unit 101 from an upstream location or upstream side 202a of unit 101 to a downstream location or downstream side 202b of unit 101. The shelving unit 101 may include internal channels 200 defining the pathway for desorbing media 203 to pass through the unit, in some examples. For example, second dividers 110 may be provided which extend from the upstream side 202a to the downstream side 202b of the unit and may each include an internal channel 200 defined by dividers 110 that is fluidly coupled with at least one manifold 202 with at least one inlet 204 to receive the inflowing desorbing media 203a. The dividers may be also referred to as support members for the shelving unit 101 as the dividers may be formed to simultaneously support the unit 101 and provide internal channels 200 that direct the media flow and separate the flow into flows 203b. In the figure, the white arrows 203b illustrate the downstream progress and distribution of the incoming media flow 203a as the divided flow 203b enters into spaces 104 and subsequently further separates into lesser or divided flows as the flow is distributed within the sorbent articles disposed within the spaces 104 during the desorption process. As shown in FIGS. 1B and 1C, the lesser or divided flow (e.g., 103d) passes from one space 104 to another space 104.

The frame structure 102 of the shelving unit 101 which supports at least one sorbent article 106 therein has an upstream location 202a and a downstream location 202b facilitating the passage of desorbing media. The shelving unit 101 includes at least one manifold 202 defining at least one inlet 204 configured to receive the desorbing media 203a at the upstream location 202a of the shelving unit 101. The shelving unit 101 also includes a set of support members or support structure (also referred to as the dividers 108 and 110) forming a plurality of housing portions (or spaces) 104 in which the sorbent article is housed. The first support members or dividers 108 extend parallel to each other in a first orientation, and the second support members or dividers 110 extend parallel to each other in a second orientation different from the first orientation. The orientations may be vertical and horizontal, and based on the orientation of the shelving unit 101 the designation may be interchangeable; for example, the first support members or dividers 108 are the “vertical” members in FIG. 1A, but in FIG. 2 the first support members or dividers 108 are the “horizontal” members.

With further reference to FIG. 2, the second support members or dividers 110 include the internal channels 200 extending from and fluidly coupled with the inlet 204 for the channels 200 to receive the desorbing media to facilitate adsorption. The channels 200 have perforations 206 (also referred to as holes, openings, or apertures) through which the desorbing media may pass into the housing portions (or spaces) 104, as shown by the white arrows.

In some examples, a single channel 200 may have a first set of perforations 206A facing one way and a second set of perforations 206B facing another (opposite) way, where the two sets may direct the desorbing media into different housing portions (or spaces) 104 within the shelving unit 101. A single support member or divider 110 may, in some examples, include a first surface (e.g., top surface) 208A defining a first set of openings or perforations 206A, and a second surface (e.g., bottom surface) 208B opposite from the first surface and defining a second set of openings or perforations 206B, such that the first set of openings or perforations 206A are positioned offset from the second set of openings or perforations 206B. In some examples, the openings or perforations 206 have various opening sizes configured to evenly distribute the desorbing media across different sections of the housing portion. For example, the openings or perforations 206 located closer to the upstream location 202a of the frame 102 may have smaller opening sizes compared to the openings or perforations 206 located closer to the downstream location 202b of the frame 102.

In the example illustrated in FIG. 3A, the opening 206 is part of an extension portion (also referred to as “dimples”) 300 formed in the second support members or dividers 110. The second divider 110 includes the extension portions 300 formed around the first set of openings or perforations 206A on the first surface 208A and around the second set of openings or perforations 206B on the second surface 208B, the extension portions 300 extending inwardly into the internal channel 200 from the surfaces 208A and 208B. The extension portion 300 in some examples has a funnel portion 302 that extends from the surrounding surface 208 toward the perforation 206 in an inward direction toward the internal channel 200.

In some examples, only the uppermost second support member 110A may include perforations 206B along only the bottom surface 208B of the support member 110A, and only the lowest horizontal support member 110B may include perforations 206A along only the top surface 208A of the support member 110B. As the desorbing media 203a enters, the desorbing media 203b travels through the hollow horizonal support members 110 and exits through the perforations 206 (e.g., as the flow of media stream 103c shown in FIG. 1B). In some examples, these perforations 206 may vary in size based on engineering fundamentals in an effort to provide uniform steam supply and coverage.

Beneficially, as illustrated in FIGS. 3A and 3B, the extension portions 300 formed on the first surface 208A may be configured to form funnels or other gravity-fed or wicking shapes through which liquid water that is condensed inside the housing portion 104 is allowed to pass into the internal channel 200, and the extension portions 300 formed on the second surface 208B are configured to form a reservoir 304 into which the condensed liquid water is configured to be gathered inside the internal channel 200, as shown in FIG. 3B.

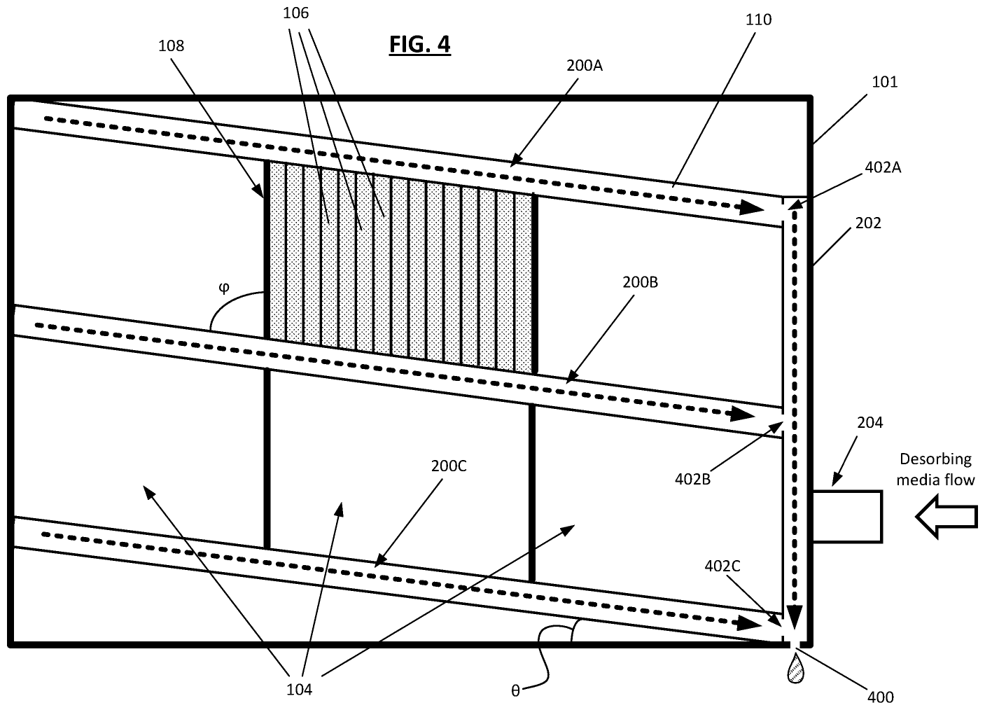

Referring to the combination of FIGS. 2, 3A, and 3B, in some examples, the DAC device 100 may include an upstream location 202a and an opposing downstream location with an inflow 203a received by the DAC device 100 at the upstream location 202a, and the DAC device 100 further includes a plurality of cartridges which are disposed adjacent to each other, with each cartridge supporting a plurality of sorbent articles 106. In some examples, the cartridges define the spacings or housing portions 104 in which the sorbent articles 106 may be disposed. For example, in FIGS. 1B and 4, the sorbent articles 106 may be supported by one or more cartridges, and in FIG. 1C, the sorbent article sets 106A through 106F may be supported by multiple cartridges, such as one or more cartridges supporting each set 106A through 106F. In some examples, the plurality of cartridges may include bottom cartridges and top cartridges that are disposed above bottom cartridges. The top and bottom cartridges each extends between the upstream location 202a and the downstream location 202b. In some examples, the internal channel 200 may include a top channel 200A, a bottom channel 2000, and a middle channel 200B. The top channel 200A may be disposed above the top cartridges and extend along a length of the top cartridges to collect water provided by a top portion of the inflow, labeled in FIG. 2 as “203b (top)”. The bottom channel 2000 may be disposed below the bottom cartridges and extend along a length of the bottom cartridges to collect water provided by a bottom portion of the inflow, labeled in FIG. 2 as “203b (bottom)”. The middle channel 200B may be disposed between the top and bottom cartridges and extend along at least one of the top cartridge length and the bottom cartridge length to collect water provided by a middle portion of the inflow, labeled in FIG. 2 as “203b (middle)”. The DAC device 100 may also include a common outlet, such as a drain or outlet 400 as shown in FIG. 4, that is disposed to receive water from at least one of the top channel 200A, the middle channel 200B, and the bottom channel 2000.

Referring to FIGS. 3A, 3B, and 4, in some examples, the top channel 200A may include a top-channel upper surface 308A disposed over a top-channel lower surface 310A within the top channel 200A. The top-channel lower surface 310A may include reservoirs 304A and perforations 206 disposed between the reservoirs 304A. The top-channel upper surface 308A may include top-channel drip points 306A that are shaped to collect water over top-channel reservoirs 304A. The top-channel reservoirs 304A may communicate to deliver the water to a top-channel outlet 402A communicating with the common outlet 400, as shown in FIG. 4. In some examples, the bottom channel 2000 may include a bottom-channel upper surface 308C disposed over a bottom-channel lower surface 310C within the bottom channel 2000. The bottom-channel lower surface 310C may include a bottom-channel reservoir 304C. The bottom-channel upper surface 308C may include perforations 206 defining bottom-channel drip points 306C shaped to collect water over the bottom-channel reservoir 304C. The bottom-channel reservoir 304C may communicate to deliver the water to a bottom-channel outlet 402C communicating with the common outlet 400. In some examples, the middle channel 200B includes a middle-channel upper surface 308B disposed over a middle-channel lower surface 310B within the middle channel 200B. The middle-channel lower surface 310B may include reservoirs 304B and perforations 206 disposed between the reservoirs 304B. The middle-channel upper surface 308B may include perforations 206 defining middle-channel drip points 306B shaped to collect water over the middle-channel reservoirs 304B. The middle-channel reservoirs 304B may communicate to deliver the water to a middle-channel outlet 402B communicating with the common outlet 400.

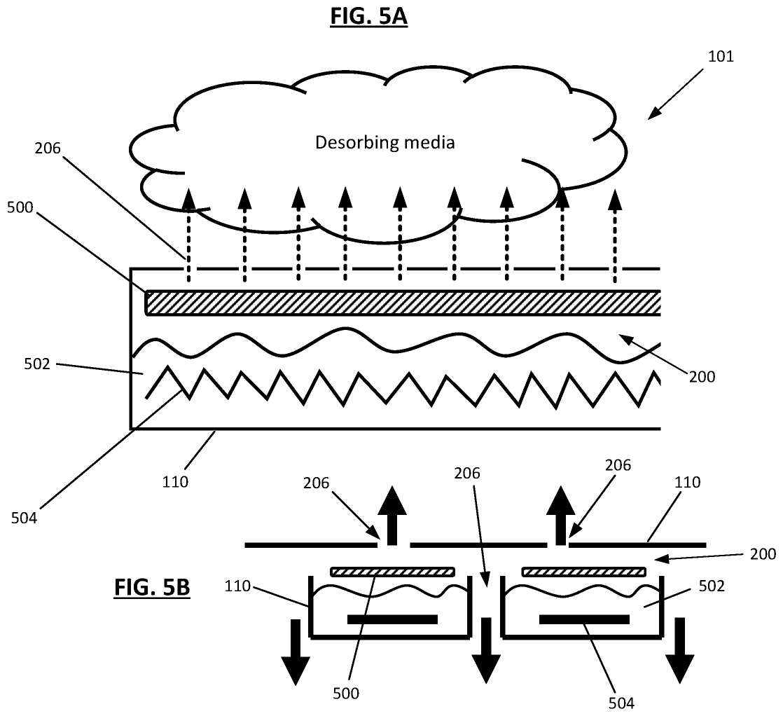

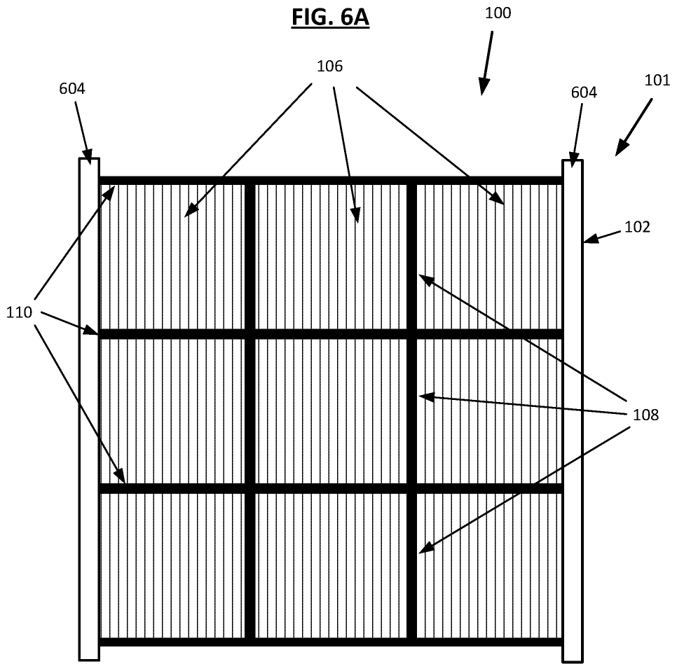

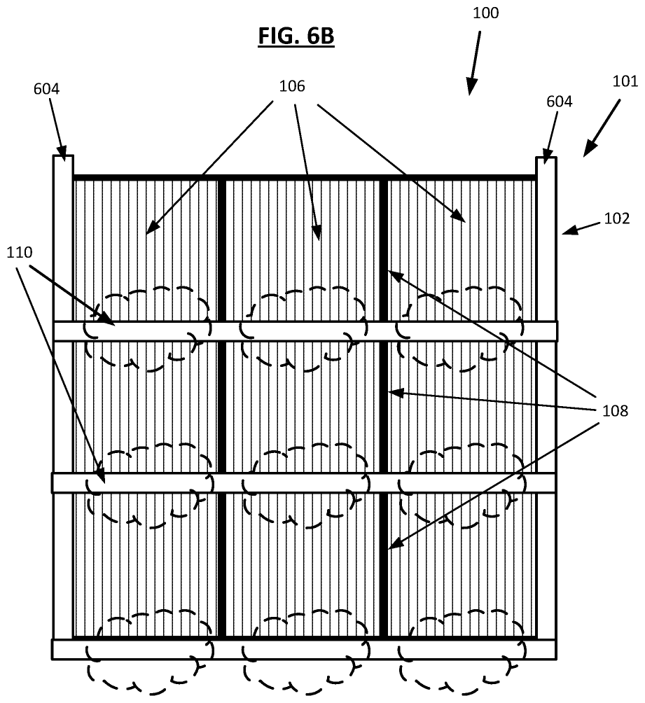

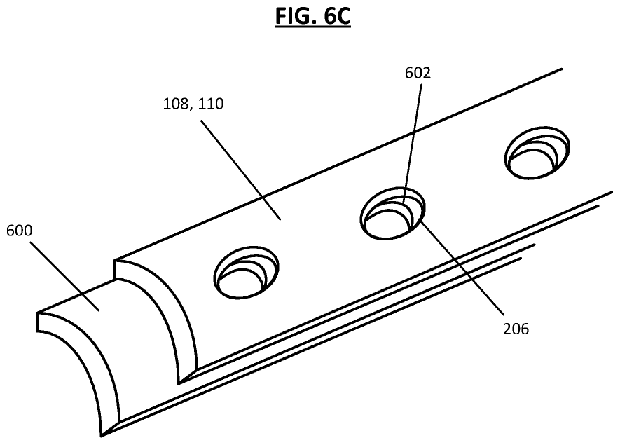

In some examples, the manifold 204 may be disposed between the inflow 203a and at least one of the top channel 200A, the bottom channel 2000, and the middle channel 200B. Referring to FIG. 5, in some examples, the top channel 200A includes a top-channel cooling channel 500 that is configured to facilitate collecting water by cooling steam located inside the top channel 200A. in some examples, the top channel 200A may include a top-channel heating element 504 that is configured to generate steam using the water collected inside the top channel 200A by heating the water located inside the top channel 200A. In some examples, the bottom channel 2000 includes a bottom-channel cooling channel 500 that is configured to facilitate collecting water by cooling steam located inside the bottom channel 2000. In some examples, the bottom channel 2000 includes a bottom-channel heating element 504 that is configured to generate steam using the water collected inside the bottom channel 2000 by heating the water located inside the bottom channel 2000. In some examples, the middle channel 200B includes a middle-channel cooling channel 500 that is configured to facilitate collecting water by cooling steam located inside the middle channel 200B. In some examples, the middle channel 200B includes a middle-channel heating element 504 that is configured to generate steam using the water collected inside the middle channel 200B by heating the water located inside the middle channel 200B. Referring to FIG. 6C, the DAC device 100 may include a perforation control mechanism 600 that is operatively coupled with the perforations 206 and is configured to control opening and closing of the perforations 206.

Referring back to FIGS. 3A and 3B, in some examples, the uppermost second support member 110A may include a plurality of dimpled surfaces 306 without any openings, such that the dimpled surfaces 306 cause condensation formed on the surface to collect as droplets at the tip portion of the dimpled surface 306 as shown in FIG. 3B, which would be collected in the reservoir 304 located underneath. As desorbing media, which in some examples may be steam, cools and condenses, liquid water forms on surfaces of the sorbent articles 106 and the shelving unit 101.

When the collection of liquid water reaches a critical size within the reservoir 304 or on another water-receiving surface to cause water droplets to form, the forces of surface tension and gravity will act upon the water droplets to fall downward. The shelving unit 101 is designed to collect liquid water from the sorbent articles 106 above, such as via the dimpled perforations guiding water to enter the frame structure 102, and this prevents or reduces the chance of the upper sorbent articles (e.g., 106A, 106B, 106C) located in an upper housing portion causing the lower the sorbent articles (e.g., 106D, 106E, 106F) located in a lower housing portion to receive water from the upper articles and be soaked with water from condensation received from adjacent articles.

The locations of the dimpled surfaces 306 and the reservoirs 304 may be configured in such a way that the dimpled surfaces 306 and the perforations 206 are not in alignment with respect to a vertical axis, for example being offset from each other to inhibit flow through from an upper article to a lower article. Furthermore, in some examples, the lowest second support member 110B may have a substantially flat portion that forms a shallow or low-volume reservoir 304C as illustrated in FIG. 3B. The aforementioned configurations also offer benefits including, but are not limited to, for example, reducing the dissipation of desorbing media as the desorbing media passes through the sorbent articles, and also controlling condensation within the structural frame of the shelving unit, for example by preventing or reducing the risk of condensation formed in an upper housing portion being transferred to a lower housing portion located beneath it.

In FIG. 4, the shelving unit 101 is tilted by an angle (θ) with respect to the bottom surface of the shelving unit, respect to true horizontal, and/or with respect to the Earth's surface. The angle θ may be any suitable angle, for example from 1 degree to 3 degrees, from 3 degrees to 5 degrees, from 5 degrees to 8 degrees, from 8 degrees to 10 degrees, from 10 degrees to 13 degrees, from 13 degrees to 15 degrees, from 15 degrees to 18 degrees, from 18 degrees to 20 degrees, from 20 degrees to 25 degrees, from 25 degrees to 30 degrees, from 30 degrees to 35 degrees, from 35 degrees to 40 degrees, from 40 degrees to 45 degrees, from 45 degrees to 50 degrees, from 50 degrees to 55 degrees, from 55 degrees to 60 degrees, 1 degree to 60 degrees, or any other suitable range or value therebetween. The tilting allows liquid (e.g., water from condensation) inside the channels 200 to drain in a predetermined direction as shown by the dotted arrows shown leading to a drain or outlet 400 for the redirected water. The drain or outlet 400 may be fluidly coupled with the manifold 202 and located in a separate location from the inlet 204. The sorbent articles 106 may be preconfigured in the form of a parallelogram as shown, in order to facilitate flat-plate sorbent polymer composite (SPC) to remain vertical and also allows all components of SPC to be substantially identical, as well as allowing the shape of the sorbent articles 106 to conform to the shape or size of the cartridge support unit, e.g., the housing portions 104 of the shelving unit 101.

In some examples, the tilt may be defined by the angle (ϕ) between the first orientation of the first support member or divider 108 and the second orientation of the second support member or divider 110, or by a corresponding angle provided in articles 106 or cartridges supporting articles 106. When the first support members 108 are vertical and the second support members 110 are horizontal (or the articles/cartridges provide corresponding vertical and horizontal surfaces), the angle ϕ therebetween is 90 degrees. In the tilted configuration, the angle ϕ therebetween may be from 30 degrees to 35 degrees, from 35 degrees to 40 degrees, from 40 degrees to 45 degrees, from 45 degrees to 50 degrees, from 50 degrees to 55 degrees, from 55 degrees to 60 degrees, from 60 degrees to 65 degrees, from 65 degrees to 70 degrees, from 70 degrees to 75 degrees, from 75 degrees to 78 degrees, from 78 degrees to 80 degrees, from 80 degrees to 83 degrees, from 83 degrees to 85 degrees, from 85 degrees to 87 degrees, from 87 degrees to 89 degrees, from 30 degrees to 89 degrees, or any other suitable range or value therebetween. As such, the condensation is directed toward the outlet 400 as caused by the tilt such that the condensation collected from the sorbent articles 106 in the housing portions 104 flow toward a predetermined direction, using gravity to increase a delivery of water to the outlet 400.

In FIGS. 5A and 5B, the second support members or dividers 110 may include an internal channel 200 extending from and fluidly coupled with the inlet for the internal channel to collect water, and at least one cooling channel 500 located inside the internal channel 200 and configured to facilitate collecting liquid (e.g., water) by cooling the desorbing media (e.g., steam) located inside the internal channel 200. The divider 110 may also include (or instead may have) at least one heating element 504 located inside the internal channel 200 and configured to generate the steam using the water collected inside the internal channel 200 by heating the water located inside the internal channel 200. Furthermore, the divider 110 may include a plurality of openings (perforations) 206 through which (1) the steam that is generated in the internal channel 200 is configured to pass into the housing portion 104 in which the sorbent article 106 is housed to facilitate adsorption, and (2) the condensation formed within the housing portion 104 is configured to pass into the internal channel 200.

In some examples, steam is created within the shelving unit 101 using a submerged heating element 504. Since steam may have a temperature that is at or greater than 100 degrees C. at sea level atmospheric pressures, a chilled water circuit (which may be part of or included in the cooling channel 500) can be included just above water level to control temperature by changing the temperature and flow rate of the circuit (e.g., in the cooling channel 500). Condensation in the chamber or space (e.g., of the housing portion 104) can also be recollected into the same shelving unit 101. Beneficially, by generating steam closer to the sorbent article 106, heat losses may be reduced, insulation design may be improved, and tighter control may be achieved. Chilled water may also beneficially serve to cool down chamber or spacing (e.g., of the housing portion 104) to reduce cycle time.

In some examples, the heating element 504 may include integrated heating of individual sorbent articles 106 of packages of sorbent articles 106. For example, integrated flexible resistive heaters (with holes) may act as active insulation to reduce the need for heating individual chambers of the housing portions 104. The heating elements 504 may also take the form of a jacket disposed around all or part of the sorbent articles 106. Beneficially, pre-heating of the sorbent articles 106 may also reduce condensation. In some examples, steam may be directed to point upward or downward as shown by the bold arrows in FIG. 5B.

FIGS. 6A and 6B show that, in some examples, the DAC device 100 includes the shelving unit 101 containing sorbent articles 106 therein such that the first support elements or dividers 108 and/or the second support elements or dividers 110 may be formed as or include a plurality of rods or pipes, and each of the rods or pipes may be hollow and defines the internal channel 200 used during adsorption and desorption processes. In some examples, chilled water may pass through an active insulation mechanism 604 that is attached external to the frame structures 102 of the shelving unit 101. The active insulation mechanism may include one or more channels operating to cool down the frame structures in order to cool down the desorbing media and form condensation. Furthermore, hot steam may pass through the rods or pipes to heat up the frame structures in order to heat up the condensation to provide water vapor inside the frame structures. The water vapor may then be provided back into the sorbent articles through holes or openings in the rods or pipes, continuing the adsorption and desorption cycle. In some examples, the openings or perforations 206 may be controllable to close or open as needed at different stages during adsorption and desorption.

FIG. 6C shows a perforation control mechanism 600 which may be implemented with or coupled with the divider (either 108 or 110) according to some examples disclosed herein. The divider 108 or 110 has a plurality of openings or perforations 206, which can be opened or closed using the mechanism 600. For simplicity, the figure only shows a portion of the divider 108 or 110 and the mechanism 600 surrounding the relevant perforations 206. In some examples, the mechanism 600 may be a smaller tube which is inserted into and to be disposed within the divider 108 or 110 which may be a tube or a tubular construct. In some examples, the mechanism 600 may be a piece of metal having a curvature which aligns with the inner curvature of the divider 108 or 110, for example. The mechanism 600 also includes a plurality of openings or perforations 602 which align with the positions of the perforations 206 of the divider 108 or 110.

As such, when aligned in a first configuration such that the perforations 206 and 602 are in line with each other, fluid may be allowed to pass through the perforations and into the surrounding environment from within the channel 200. In a second configuration where the perforations 206 and 602 are in a staggered configuration, the wall of the divider 108 or 110 may block the perforations 602, and the wall of the mechanism 600 may block the perforations 206, thereby preventing fluid from flowing therethrough. The user or the device which controls the opening and closing of the perforations may do so by, for example, twisting and/or sliding the mechanism 600 with respect to the divider 108 or 110 in order to switch between the first (open) configuration and the second (closed) configuration. Alternatively, the mechanism 600 may include tabs or flaps which may be activated to open or close the respective perforations 206 in the divider 108 or 110, in order to switch between the first and second configurations.

In some examples, the frame structure 102 of the shelving unit 101 includes a first set of support members 108 and a second set of support members 110, each of which is hollow and defines an internal channel 200 to be used during adsorption and desorption processes. In some examples, chilled water may pass through the first support members 108 to cool down the frame 102 in order to cool down the desorbing media and form condensation. Furthermore, hot steam may pass through the first and second support members to heat up the frame 102 in order to heat up the condensation to provide water vapor inside the frame 102. The water vapor may then be provided back into the sorbent articles 106 through holes or openings 206 (not shown) in the second support members 110, continuing the adsorption and desorption cycle. In some examples, the openings may be controllable to close or open as needed at different stages during adsorption and desorption.

In some examples, the individual sorbent articles 106 may be removed from the shelving unit 101 and replaced with another sorbent article 106, for example when replacing the old sorbent material(s) contained inside the shelving unit 101 with new sorbent material(s). The removing and replacing of the sorbent articles 106 may be performed without removing the entire DAC device 100 from inside the DAC reactor, such that if only one sorbent article needs to be removed, it may be removed (and subsequently replaced) without affecting one or more of the other cartridges that form the DAC device 100.

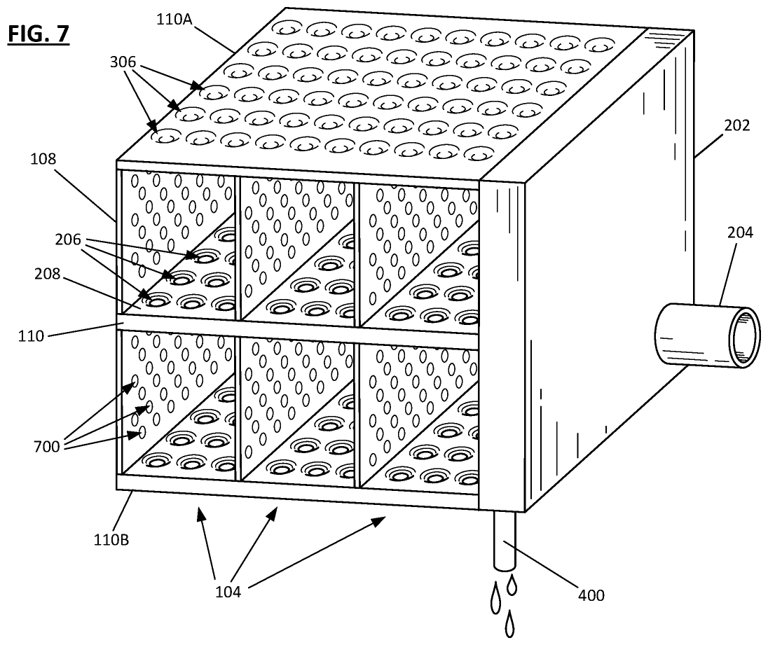

FIG. 7 shows an example of the shelving unit 101 for the DAC device 100 according to embodiments disclosed herein. The shelving unit 101 includes a plurality of first support members 108 and second support members 110, where the first support members are substantially vertical, and the second support members are substantially horizontal (or angled as per the example of FIG. 4). The first support members 108 may include a plurality of holes or openings 700 extending through the support members to allow air or fluid to pass between the compartments or housing portions 104 as defined at least partially by the first and second support members.

The second support members 110 includes the uppermost (top) support member 110A and the lowest (bottom) support member 110B such that the support member 110A includes a plurality of dimpled surfaces 306 (or dimpled portions of the surface) that are “closed” or having no openings therein, such that the dimpled surfaces 306 cause condensation formed on the surface to collect as droplets at the tip portion of the dimpled surface 306 as shown in FIG. 3B. The second support members that are not the uppermost support member 110A (for example, the second support members 110 in the middle or the lowest support member 110B) may each have a surface 208 having perforations 206 that point downward to form “open” dimples (that is, configured to direct condensation or water droplets into the internal channel within the support member 110), where the open dimples may have the shape of a funnel, as also shown in FIG. 3B.

The shelving unit 101 of FIG. 7 also includes the manifold 202 that is fluidly coupled with the internal channels of the second support members 110. The manifold 202 may be attached to the second support members 110 to form a sidewall of the shelving unit 101 as shown. The manifold 202 includes at least one inlet 204 through which desorbing media may be provided, and at least one outlet 400 through which the collected condensation within the internal channels may be directed to exit the shelving unit 101, as further explained in view of FIG. 4.

Beneficially, switching steam supply circuit with chill water may reduce cycle time. Running steam supply in walls may provide active insulation and reduce condensation. Cooling water is prevented from exiting steam holes. The individual sorbent articles may potentially snap into walls of the shelving unit to add to a circuit while also providing structural support and assisting the locating of the sorbent articles.

Furthermore, beneficially, the shelving unit allows for discretized storage of sorbent articles. The shelving unit also provides uniform steam distribution to each sorbent article or modular cartridges of sorbent article. The shelving unit allows each sorbent article to cost less in both manufacturing and shipping by obviating the need for individual frames for each sorbent article. In some examples, the shelving unit facilitates cross-flow between sorbent articles, therefore facilitating water to be collected and reused as steam vapor (e.g., via heating by an external heating device) for a more self-sustaining DAC system, as well as for water to be drained more efficiently, for example using the tilted or angled configuration of the shelving unit as disclosed herein. In some examples, providing the shelving unit with integrated heating/cooling features allows for the cooling of the steam vapor inside the shelving unit in order to facilitate efficient formation of water to be used in a subsequent adsorption/desorption cycle, and/or heating of the collected water in order to facilitate efficient use of the desorbing media for a self-sustaining DAC system.

The sorbent material as referred to herein may include any suitable carbon dioxide adsorbing material which may include, but is not limited to, an ion exchange resin (e.g., a strongly basic anion exchange resin such as Dowex™ Marathon™ A resin available from Dow Chemical Company), zeolite, activated carbon, alumina, metal-organic frameworks, polyethyleneimine (PEI), or another suitable carbon dioxide adsorbing material, such as desiccant, carbon molecular sieve, carbon adsorbent, graphite, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, graphitic adsorbent, carbon fiber, carbon nanotube, nano-materials, metal salt adsorbent, perchlorate, oxalate, alkaline earth metal particle, ETS, CTS, metal oxide, chemisorbent, amine, organo-metallic reactant, hydrotalcite, silicalite, zeolitic imidazolate framework and metal organic framework (MOF) adsorbent compounds, and combinations thereof, for example as further disclosed in U.S. application Ser. No. 18/199,506 (W. L. Gore & Associates, Inc.), the disclosure of which is incorporated herein by reference in its entirety for all purposes.

### Carbon Dioxide Removal Service Providers

Also disclosed herein are methods for removing gaseous carbon dioxide (CO₂) from the atmosphere using any suitable means, methods, processes, or devices for atmospheric CO₂ removal as disclosed herein. In some examples, a carbon dioxide removal service provider that may be a person, a device, an atmospheric processing facility, a carbon dioxide removal plant, software, an internet site, an electronic interface, an organization, or a corporate agent or entity (that may include a control center, a headquarters, a data management center, an intermediary data collection or processing center, or facilitating organizations that provide information and/or control functions for or services to the provider) or an electronic device or display associated with or accessible to the provider may receive and/or become aware of information about a dispersion of a first quantity of gaseous CO₂ in the atmosphere at a first location. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. In some examples, the information may be in the form of an electronic communication (e.g., first electronic communication) that includes information about the dispersion of the first quantity of gaseous CO₂ into the atmosphere at the first location that may be received from and/or provided to a computing and/or electronic display device.

The carbon dioxide removal service provider may initiate an immediate or subsequent separating of or a method of separating a second quantity of gaseous CO₂ at a second location which may be different from the first location. The second location may be located remote to the first location such as, for example, when the first location is in a populated commercial area and the second location is near a geothermal or other hazardous energy source that powers the separating process at the second location. The second quantity may be at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. In some examples, the separating may be initiated by the sending or transmitting of instructions or confirmation to a location that has the capability of performing such separating. In some examples, the separating may be performed by a carbon capture device capable of carrying out any method for separating gaseous CO₂ from a gas mixture in the form of ambient air, as disclosed herein. In some examples, the distance from the first location to the second location may be from 100 km to 200 km, from 200 km to 500 km, from 500 km to 800 km, from 800 km to 1000 km, from 1000 km to 2000 km, from 2000 km to 3000 km, from 3000 km to 4000 km, from 4000 km to 5000 km, from 5000 km to 6000 km, from 6000 km to 7000 km, from 7000 km to 8000 km, from 8000 km to 9000 km, from 9000 km to 10,000 km, from 10,000 km to 15,000 km, from 15,000 km to 20,000 km, or any other suitable value or range therebetween.

The carbon dioxide removal service provider may initiate a reporting of data regarding the second quantity that will be, is being, or has been removed from the atmosphere. The initiating may be initial steps taken to start an immediate or subsequent reporting of data that may be performed via any suitable means of electronic communication or data transmission which may be wired or wireless. In some examples, the reporting may involve the preparing of information to be included in such reporting or later reporting and the subsequent sending or transmitting of instructions or confirmation to another entity or device which has the capability of starting or fully performing such reporting. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication may be transmitted to the computing or display device. In some examples, the second electronic communication may be transmitted to an additional computing or display device that may be separate or different from the aforementioned computing or display device.

In some examples, the method for removing gaseous CO₂ from the atmosphere may involve a carbon dioxide removal service provider (as described above) that may receive and/or become aware of information about a first quantity of gaseous CO₂ which may include a dispersion of gaseous CO₂. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. Such quantity may represent the amount of gaseous CO₂ being dispersed at a location (e.g., in tons of CO₂) and/or the rate of dispersion (e.g., in tons of CO₂ per minute, hour, day, etc.). In some examples, the information may be received as an electronic communication from another entity or device which sends or transmits instructions concerning gaseous CO₂ removal as disclosed herein. In some examples, an electronic communication (e.g., first electronic communication) that includes information about the dispersion of the first quantity of gaseous CO₂ that may be received from and/or provided to a computing and/or electronic display device.

The carbon dioxide removal service provider may separate or begin separation of a second quantity of gaseous CO₂ from the atmosphere, where the second quantity is at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. In some examples, the separating may be performed by a carbon capture device capable of carrying out any method for separating gaseous CO₂ from a gas mixture in the form of ambient air, as disclosed herein.

The carbon dioxide removal service provider may report the data regarding the second quantity that will be, is being, or has been removed from the atmosphere. The reporting of data may be performed via any suitable means of electronic communication or data transmission which may be wired or wireless. In some examples, the reporting may be in response to receiving instructions or confirmation as transmitted from another entity or device which has the capability of starting or fully performing such reporting. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication may be transmitted to the computing or display device. In some examples, the second electronic communication may be transmitted to an additional computing or display device that may be separate or different from the aforementioned computing or display device.

In some examples, the method for removing gaseous CO₂ from the atmosphere may involve a carbon dioxide removal service provider (as described above) that may transmit, emit, or send out information about a dispersion of a first quantity of gaseous CO₂ into the atmosphere at a first location. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. The transmitting may be an emitting and/or a sending out performed via any suitable means of electronic communication or data transmission which may be wired or wireless that may not be received by the intended recipient or any recipient. In some examples, the information may be in the form of an electronic communication (e.g., first electronic communication) that includes information about the dispersion of the first quantity of gaseous CO₂ into the atmosphere at the first location that may be transmitted, emitted, and/or sent out to a computing device with such transmission, emitting, and/or sending out not necessarily being received by any recipient.

The carbon dioxide removal service provider may request an immediate or subsequent separating of or a method of separating a second quantity of gaseous CO₂ from the atmosphere at a second location. The second location may be located remote to the first location such as, for example, when the first location is in a populated commercial or industrial area and the second location is near a geothermal or other hazardous energy source that powers the separating process at the second location. The second quantity may be at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. The requesting of the separating or an initiation of the separating may be performed via any suitable means of electronic communication or data transmission which may be wired or wireless. In some examples, the requesting may be by sending, emitting, or transmitting of instructions to a start command to a location that has the capability of starting or fully performing such separating. In some examples, the separating may be performed by a carbon capture device capable of carrying out any method for separating gaseous CO₂ from a gas mixture in the form of ambient air, as disclosed herein. In some examples, the distance from the first location to the second location may be from 100 km to 200 km, from 200 km to 500 km, from 500 km to 800 km, from 800 km to 1000 km, from 1000 km to 2000 km, from 2000 km to 3000 km, from 3000 km to 4000 km, from 4000 km to 5000 km, from 5000 km to 6000 km, from 6000 km to 7000 km, from 7000 km to 8000 km, from 8000 km to 9000 km, from 9000 km to 10,000 km, from 10,000 km to 15,000 km, from 15,000 km to 20,000 km, or any other suitable value or range therebetween.

The carbon dioxide removal service provider may receive a reporting, an indication of such reporting, and/or an indication of an availability of data regarding the second quantity that will be, is being, or has been removed from the atmosphere. The receiving of the reporting does not require examination or review by a human, may be achieved by simply making the reporting accessible even if subsequently never reviewed or acknowledged, and/or may be performed via any suitable means of electronic communication or data transmission which may be wired or wireless. In some examples, the receiving of the reporting may regard the second quantity, such as how much of the gaseous CO₂ was separated within a predetermined amount of time, for example within a day, a week, a month, etc. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication is received from the computing device. In some examples, the second electronic communication is received in response to the transmitting of the first electronic communication. In some examples, the second electronic communication is received from the computing or display device in response to the transmitting of the first electronic communication to the computing or display device.

As used herein, “receiving” information is to be understood as an act of “receiving” which requires only one party (or entity, device, etc.) to perform, such that a separate party for performing the act of “sending” is not required.

As used herein, “initiating” a separating (or a method of separating) is to be understood as an act of “initiating” that includes an initial or completed act of preparing or dispatching instructions to another party or device with the intent that there is an execution or start of a separating process or the association of an already started separating process with the initiating step. For example, the act of “initiating” the separating of gaseous CO₂ may cause a carbon capture device to subsequently receive an instruction, either directly or indirectly (e.g., via intermediary entities or devices) to initiate the separating, in response to which the carbon capture device operates accordingly. In another example, the act of “initiating” a separating (or a method of separating) gaseous CO₂ may include a carbon dioxide removal service provider associating carbon dioxide that has already been removed from the atmosphere (or presently in an active removal process) with a subsequent initiating of a separating. It will be appreciated that the instruction received by the carbon capture device need not be provided as part of such an “initiating” operation. Further, the act of “separating” of the CO₂, for example, is therefore not necessarily part of the act of “initiating” such separating, such as when the “initiating” of the separating is performed by a first party and the subsequent “separating” itself is performed by a second party different from the first party. Furthermore, the act of “separating” does not need to be accomplished or fully completed, either by the first party or the second party. It will also be appreciated that the act of initiating can be fully performed in one jurisdiction or country even though an acknowledgement of the initiating or an act subsequent to or associated with the initiating takes place in a different jurisdiction or country.

As used herein, “initiating” a reporting (e.g., of data) is to be understood as an act of “initiating” that includes the initial or complete act of preparing or dispatching instructions to another party to prepare, start, or complete the reporting at a later time. The act of “reporting” any data, for example, is therefore not necessarily part of the act of “initiating” such reporting, such as when the “initiating” of the reporting is performed by a first party (the initiating party) and the “reporting” itself is performed by a second party (the reporting party) different from the first party (the initiating party). Furthermore, the act of “reporting” does not need to be accomplished or fully completed, either by the first party or the second party. It will be appreciated that the act of initiating can be fully performed in one jurisdiction or country even though an acknowledgement of the initiating or an act subsequent to or associated with the initiating takes place in a different jurisdiction or country.

As used herein, “reporting” data is to be understood as an act of “reporting” which may require only one party (reporting party) to perform. Furthermore, the act of “reporting” does not require the receipt (or confirmation of receipt) of such reporting by another party (receiving party). The reporting may be a storage of the data or display of the data at a location that is accessible to an intended recipient, and may still be considered to be a reporting even when the intended recipient does not access or review the data.

As used herein, “transmitting” information is to be understood as an act of “transmitting” which may require only one party (the transmitting party) to perform. Furthermore, the act of “transmitting” does not require a receiver (e.g., receiving party) or receipt (e.g., confirmation of receipt) of the information that is transmitted.

As used herein, “requesting” a separating (or initiation of a method of separating) is to be understood as an act of “requesting” which may require only one party (the requesting party) to perform. Also, the act of “separating” which is requested by the act of “requesting” may be performed by another party (the separating party). Furthermore, the act of “requesting” may be only intended or started and does not need to be accomplished or fully completed (e.g., when no separating results from the act of “requesting” such separating). In an example, the act of “requesting” a separating (or initiation of a method of separating) of gaseous CO₂ may include a carbon dioxide removal service provider associating carbon dioxide that has already been removed from the atmosphere (or presently in an active removal process) with a subsequent request for a separating. It will be appreciated that the act of requesting can be fully performed in one jurisdiction or country even though an acknowledgement of the requesting or an act subsequent to or associated with the requesting takes place in a different jurisdiction or country.

As used herein, “receiving” a reporting or an indication of the reporting is to be understood as an act of “receiving” which does not require a sender (e.g., sending party). The receiving may be a storage of the data or display of the data at a location that is accessible to an intended recipient, and may still be considered to be a receiving even when the intended recipient does not access or review the data.

As can be appreciated, the first quantity, the second quantity, and the portion of the first quantity may be estimated or projected values. It can be further appreciated that carbon dioxide gas released or dispersed at the first location may not necessarily include or be the same CO₂ molecules separated or collected at the second location, and that the second quality may be an equivalent quantity of CO₂ that was released or dispersed. The CO₂ in the portion of the first quantity may be in a non-gaseous form. The portion of the first quantity or the second quantity may refer to carbon dioxide that is entrapped in the sorbent as disclosed herein or that has been stored or otherwise converted into another form. The portion of the first quantity or the second quantity may also include gases other than carbon dioxide. For example, the second quantity may be in a non-gaseous form or combined with other materials.

As used herein, a “carbon capture device” refers to any one or more devices as disclosed herein that is capable of separating gaseous CO₂ from the atmosphere at the location at which the device is installed or located. The carbon capture device may refer to a single device or a plurality of devices, or a facility containing therein one or more such devices or component devices that act in concert. The device may include, for example, the desorbing media source(s) and the adsorber structure(s) as disclosed herein. The device may be operable by a user or operator using an electronic device. The device may generate data associated with its operation, for example as may be detected by one or more sensors and/or as may include log data, among other examples.

As used herein, an “electronic device” is capable of performing one or more electronic operations, for example a computer, smartphone, smart tablet, etc. The electronic device may include for example a display device and/or one or more processing units and one or more memory units. The processing unit may include a central processing unit (CPU), a microprocessor, system on a chip (SoC), or any other processor capable of performing such operations. The memory unit may by a non-transitory computer-readable storage medium storing one or more programs or instructions thereon which, when run on the processing unit, causes the processing unit or the electronic device to perform one or more methods as disclosed herein. The memory unit may include one or more memory chips capable of storing data and allowing storage location to be accessed by the processing unit(s), for example a volatile or non-volatile memory, static or dynamic random-access memory, or any variant thereof. In some examples, the electronic device may be referred to as a computing device.

Technical advantages of removing gaseous CO₂ from an atmosphere using the methods or processes as disclosed herein includes, but are not limited to, facilitating a network of entities and/or devices that are capable of communicating with other entities and/or devices in order to remotely provide instructions or facilitating separation and removal of gaseous CO₂ without requiring to be physically at the location to do so. Furthermore, the methods and processes as disclosed herein provide a robust network of interinstitutional communication such that each entity (which may be an institution associated with a physical location) is capable of directing or initiating the separation and removal of gaseous CO₂ at multiple locations simultaneously, as well as having the capability of flexibly changing the location at which separation and removal of gaseous CO₂ is determined to be removed. The change in location may be performed at or near real-time such that there is minimal time lag between when the instructions are provided and when the separating of gaseous CO₂ takes place at the designated location, for example. In some examples, the methods or processes as disclosed herein provides a flexible communication network in which the entity or device which performs the separation and removal of gaseous CO₂ at the designated location may provide a timely reporting (e.g., operation summary and/or invoice for the service rendered) associated with the amount of gaseous CO₂ that was removed during a predetermined time period. Such reporting may be generated automatically or manually, may be generated at a predetermined time interval (e.g., once every day, week, month, etc.) or more flexibly as manually determined (e.g., each time a user or entity requests), or may be generated in response to achieving or exceeding a predetermined threshold, including but not limited to the amount of gaseous CO₂ that was separated and removed from the atmosphere (e.g., every 1 ton, 5 tons, 10 tons, etc., of gaseous CO₂ that was removed from the atmosphere), and any other suitable conditions as determined and agreed upon by the entities involved, for example.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A shelving unit for a direct air capture (DAC) device configured to support at least one sorbent article therein and having an upstream location and a downstream location for transporting steam, the shelving unit comprising:
a set of support members forming a plurality of housing portions in which the sorbent article is housed, the support members comprising:
first support members extending parallel to each other in a first orientation; and
second support members extending parallel to each other in a second orientation different from the first orientation, wherein the second support members include:
an internal channel configured to receive the desorbing media, and
a plurality of openings through which the desorbing media that is received in the internal channel is configured to pass into the housing portion in which the sorbent article is housed to facilitate adsorption.

2. The shelving unit of claim 1, further comprising a manifold defining at least one inlet configured to receive the desorbing media at the upstream location of the frame, and the internal channel is configured to extend from and fluidly coupled with the inlet for the internal channel to receive the desorbing media.

3. The shelving unit of claim 1, wherein the internal channel includes a plurality of extension portions formed around the openings on a surface of the second support members and extending inwardly into the internal channel from the surface.

4. The shelving unit of claim 3, wherein the extension portions define a reservoir formed in the internal channel and configured to collect water condensation inside the internal channel.

5. The shelving unit of claim 1, wherein the second support members further include: at least one cooling channel located inside the internal channel and configured to facilitate collecting water by cooling the steam located inside the internal channel.

6. The shelving unit of claim 5, wherein the second support members further include: at least one heating element located inside the internal channel and configured to generate the steam using the water collected inside the internal channel by heating the water located inside the internal channel.

7. The shelving unit of claim 1, further comprising a perforation control mechanism operatively coupled with the openings configured to control opening and closing of the openings.

8. A direct air capture (DAC) device having an upstream location and an opposing downstream location with an inflow received by the DAC device at the upstream location, the DAC device comprising:
a plurality of first cartridges disposed adjacent to each other with each first cartridge supporting a plurality of first sorbent articles, the plurality of first cartridges disposed proximate to the upstream location;
a plurality of second cartridges disposed adjacent to each other with each second cartridge supporting a plurality of second sorbent articles, the plurality of first cartridges disposed between the upstream location and the plurality of second cartridges;
at least one channel extending from the upstream location through the plurality of first cartridges and through the plurality of second cartridges, a first portion of the at least one channel disposed to deliver a first portion of the inflow to the plurality of first cartridges and a second portion of the at least one channel disposed to deliver a second portion of the inflow to the plurality of second cartridges.

9. The DAC device of claim 8, further comprising:
a manifold disposed between the inflow and the at least one channel.

10. The DAC device of claim 8, wherein the second portion of the inflow does not pass through the first plurality of cartridges.

11. The DAC device of claim 8, wherein the first and second portions of the inflow each have a same concentration of a component as the first portion of the inflow engages the plurality of first cartridges and the second portion of the inflow engages the plurality of second cartridges.

12. The DAC device of claim 8, wherein the at least one channel includes a plurality of extension portions formed around openings and extending inwardly into the at least one channel.

13. The DAC device of claim 8, wherein the extension portions define a reservoir formed in the at least one channel and configured to collect water condensation inside the at least one channel.

14. The DAC device of claim 8, wherein the at least one channel includes a cooling channel configured to facilitate collecting water by cooling steam located inside the at least one channel.

15. The DAC device of claim 8, wherein the at least one channel includes a heating element configured to generate steam using the water collected inside the at least one channel by heating the water located inside the at least one channel.

16. The DAC device of claim 8, further comprising a perforation control mechanism operatively coupled with the openings configured to control opening and closing of the openings.

17. A direct air capture (DAC) device having an upstream location and an opposing downstream location with an inflow received by the DAC device at the upstream location, the DAC device comprising:
a plurality of cartridges disposed adjacent to each other with each cartridge supporting a plurality of sorbent articles, the plurality of cartridges including top cartridges disposed above bottom cartridges, the top and bottom cartridges each extending between the upstream and downstream locations;
a top channel disposed above the top cartridges and extending along a length of the top cartridges to collect water provided by a top portion of the inflow;
a bottom channel disposed below the bottom cartridges and extending along a length of the bottom cartridges to collect water provided by a bottom portion of the inflow;
a middle channel disposed between the top and bottom cartridges and extending along at least one of the top cartridge length and the bottom cartridge length to collect water provided by a middle portion of the inflow; and
a common outlet disposed to receive water from at least one of the top channel, the middle channel, and the bottom channel,
wherein the top channel includes a top-channel upper surface disposed over a top-channel lower surface within the top channel, the top-channel lower surface including reservoirs and perforations disposed between the reservoirs, the top-channel upper surface including top-channel drip points shaped to collect water over the top-channel reservoirs, the top-channel reservoirs communicating to deliver the water to a top-channel outlet communicating with the common outlet.

18. The DAC device of claim 17, wherein the bottom channel includes a bottom-channel upper surface disposed over a bottom-channel lower surface within the bottom channel, the bottom-channel lower surface including a bottom-channel reservoir, the bottom-channel upper surface including perforations defining bottom-channel drip points shaped to collect water over the bottom-channel reservoir, the bottom-channel reservoir communicating to deliver the water to a bottom-channel outlet communicating with the common outlet.

19. The DAC device of claim 17, wherein the middle channel includes a middle-channel upper surface disposed over a middle-channel lower surface within the middle channel, the middle-channel lower surface including reservoirs and perforations disposed between the reservoirs, the middle-channel upper surface including perforations defining middle-channel drip points shaped to collect water over the middle-channel reservoirs, the middle-channel reservoirs communicating to deliver the water to a middle-channel outlet communicating with the common outlet.

20. The DAC device of claim 17, wherein at least one of the top channel, the bottom channel, and the middle channel is angled to use gravity to increase a delivery of water to the common outlet.

21. The DAC device of claim 17, further comprising:
a manifold disposed between the inflow and at least one of the top channel, the bottom channel, and the middle channel.

22. The DAC device of claim 17, wherein the top channel includes a top-channel cooling channel configured to facilitate collecting water by cooling steam located inside the top channel.

23. The DAC device of claim 17, wherein the top channel includes a top-channel heating element configured to generate steam using the water collected inside the top channel by heating the water located inside the top channel.

24. The DAC device of claim 17, wherein the bottom channel includes a bottom-channel cooling channel configured to facilitate collecting water by cooling steam located inside the bottom channel.

25. The DAC device of claim 17, wherein the bottom channel includes a bottom-channel heating element configured to generate steam using the water collected inside the bottom channel by heating the water located inside the bottom channel.

26. The DAC device of claim 17, wherein the middle channel includes a middle-channel cooling channel configured to facilitate collecting water by cooling steam located inside the middle channel.

27. The DAC device of claim 17, wherein the middle channel includes a middle-channel heating element configured to generate steam using the water collected inside the middle channel by heating the water located inside the middle channel.

28. The DAC device of claim 17, further comprising a perforation control mechanism operatively coupled with the perforations configured to control opening and closing of the perforations.
